(19) United States
(12) Patent Application Publication
(10) Pub. No.: US 2004/0147225 A1
(43) Pub. Date: Jul. 29, 2004

(54) Digital music player

(75) Inventor: Tonny Chen, Chang-Hua (TW)

Correspondence Address: BRUCE H. TROXELL, SUITE 1404, 5205 LEESBURG PIKE, FALLS CHURCH, VA, 22041, US

(73) Assignee: E-Lead Electronic Co., Ltd.

(21) Appl. No.: 10/353,047

(22) Filed: Jan. 29, 2003

(51) Int. Cl. H04B 1/00

(52) U.S. Cl. 455/45

(57) ABSTRACT

A digital music player and particularly a music player capable of coupling with an audio system or a radio to broadcast digital music without altering the original design of FM, AM or cassette tape playing function, and connecting to different digital music broadcasting devices through an input port to output music through different output devices includes an input port, a data conversion unit and a power supply unit. The digital music player also transmits by radio signals to the audio system or radio for receiving and broadcasting digital music in addition to the FM, AM or cassette tape playing functions.

### BACKGROUND OF THE INVENTION

1. Field of the Invention

The invention relates to a digital music player and particularly a music player that allows users to retrieve digital music information from different digital music broadcasting devices and transmit by radio signals to an audio system or radio for receiving and broadcasting digital music in addition to FM, AM or cassette tape playing functions.

2. Description of the Prior Art

Digital music (such as MP3) has the advantages of small size, good audio quality and convenient transmission. Many multimedia products have been developed to support the broadcasting function of digital music, such as digital camera, recording pen, digital personal music player, Personal Digital Assistant (PDA), etc. However, digital music players mostly are for individual use and cannot broadcast to general public. They also cannot be coupled with a high level audio system for outputting. Moreover, the electric appliances now commonly available in the houses such as TV, audio system, radio and car stereo system usually cannot be coupled with the digital music player to output digital music. This is an issue still to be improved.

### SUMMARY OF THE INVENTION

In view of the aforesaid disadvantages, the invention aims at providing a novel digital music player that mainly includes an input port, a data conversion unit and a power supply unit. The digital music player of the invention can read digital music information from different digital music broadcasting devices and transmit by radio signals to an audio system or radio that has FM, AM or cassette tape playing functions for receiving and broadcasting digital music.

The primary object of the invention is to provide a digital music player and particularly a music player that allows users to retrieve digital music information from different digital music broadcasting devices without altering the original digital music broadcasting devices and the existing audio system and transmit by radio signals to an audio system or radio that has FM, AM or cassette tape playing functions for receiving and broadcasting digital music.

The foregoing, as well as additional objects, features and advantages of the invention will be more readily apparent from the following detailed description, which proceeds with reference to the accompanying drawings.

### BRIEF DESCRIPTION OF THE DRAWINGS

FIG. 1 is a block diagram of a first embodiment of the digital music player of the invention.

FIG. 2 is a block diagram of a second embodiment of the digital music player of the invention.

FIG. 3 is a block diagram of a third embodiment of the digital music player of the invention.

FIG. 4 is a block diagram of a fourth embodiment of the digital music player of the invention.

FIG. 5 is a block diagram of a fifth embodiment of the digital music player of the invention.

### DESCRIPTION OF THE PREFERRED EMBODIMENTS

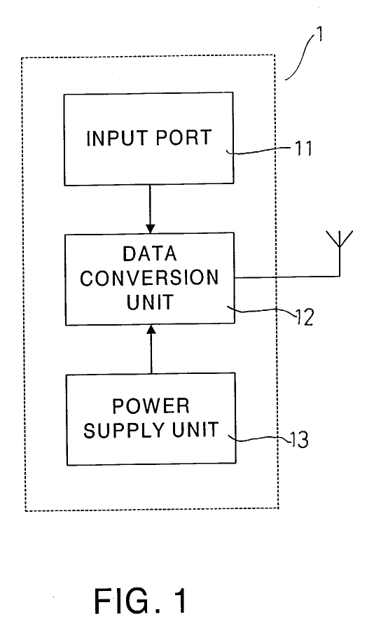

Refer to FIG. 1 for a first embodiment of the invention. The digital music player 1 of the invention mainly includes an input port 11, a data conversion unit 12 and a power supply unit 13.

The input port 11 receives music information output from the earphone jack of a digital music broadcasting device.

The data conversion unit 12 modulates the digital music transferred from the digital music broadcasting device to radio signals and emit the radio signals which are received by an audio system or radio for broadcasting. The data conversion unit may be a FM or AM emission circuit.

The power supply unit 13 provides electric power required by the digital music player 1. The electric power source of the power supply unit 13 may be batteries.

By means of the elements and construction set forth above, users may plug the output of the earphone of the digital music broadcasting device in the input port 11 of the digital music player 1 of the invention. Then the data conversion unit 12 modulates to radio signals and emits the radio signals for an audio system or radio to receive and broadcast the digital music.

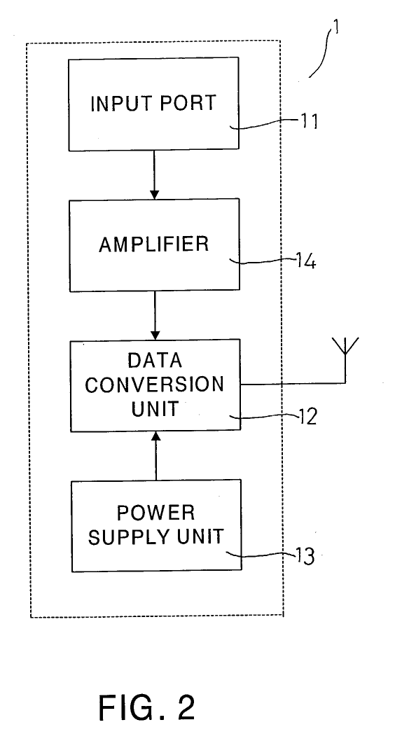

Refer to FIG. 2 for a second embodiment of the invention. In order to increase the gain of audio signal input to the data conversion unit 12, an amplifier 14 is added before the input of the data conversion unit 12 to increase the gain of the audio signal input from the input port 11.

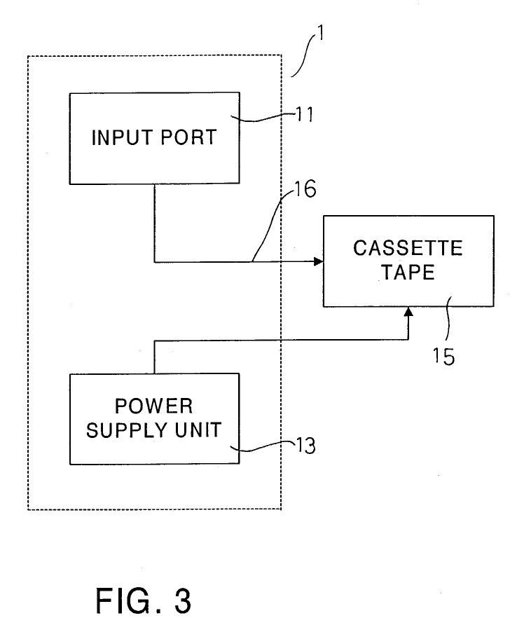

Refer to FIG. 3 for a third embodiment of the invention. In order to expand the application of the invention, the data conversion unit of the digital music player 1 may be a cassette tape 15 connected by an extension line 16 to the digital music player 1.

An user may dispose the cassette tape 15 in the cassette tape slot of an audio system or radio. The digital music player 1 transfers the digital music signals from the cassette tape 15 to the magnetic head of the audio system or radio for broadcasting the digital music (the digital music broadcast operation of the digital music player is same as the first embodiment, and the cassette tape is a medium known in the art that forms no part of the invention, thus details are omitted).

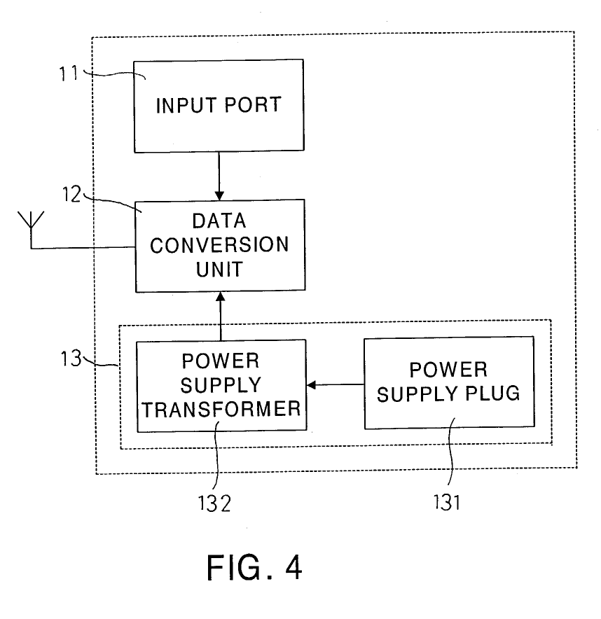

Refer to FIG. 4 for a fourth embodiment of the invention. In order to expand the power supply selection, the power supply unit 13 may include:

a power supply plug 131 for connecting to an external power supply to provide electric power to the digital music player 1, such as a household power supply plug, a car cigarette lighter, or the like; and

a power supply transformer 132 for transforming the electric power input from the power supply plug 131 to the operation voltage of the digital music player 1.

By means of the aforesaid elements, the digital music player of the invention may use the power supply of the house or car.

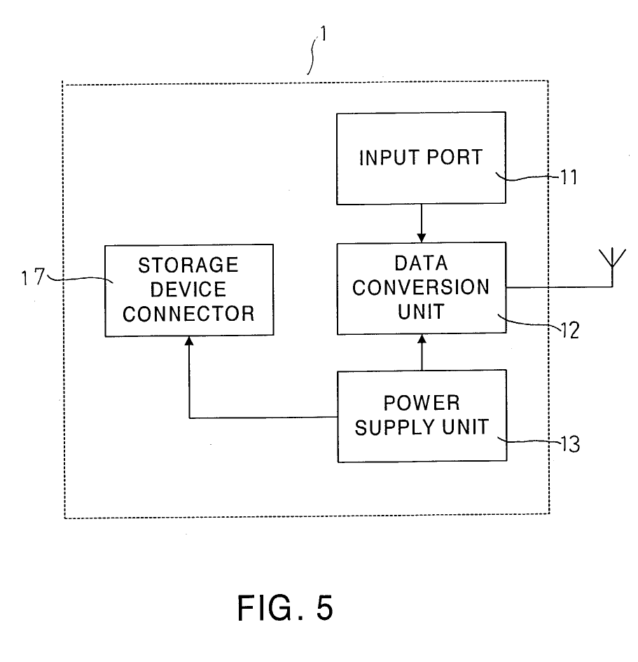

Refer to FIG. 5 for a fifth embodiment of the invention. In order to enable a digital music broadcasting device to obtain electric power from the invention and extend use time, the invention further includes a storage device connector 17 for connecting to the digital music broadcasting device, such as an insert slot of a memory card, a USB connector, or the like. The digital music broadcasting device may be a portable disk or a memory card with a USB interface (such as CF, MD, SD, MMC, SM, MS, etc.), digital camera, recording pen, digital personal music player, Personal Digital Assistant (PDA), or the like that can output digital music.

In summary, the invention, besides can input digital music information output from various digital music broadcasting devices, can also transmit by radio signals to enable audio systems and radios that have FM, AM or cassette tape playing functions to receive and broadcast digital music.

While the preferred embodiments of the invention have been set forth for the purpose of disclosure, modifications of the disclosed embodiments of the invention as well as other embodiment thereof may occur to those skilled in the art. Accordingly, the appended claims are intended to cover all embodiments which do not depart from the spirit and scope of the invention.

I claim:

1. A digital music player for retrieving music information output from a music broadcasting device and allowing an audio system without digital music playing function to broadcast digital music, comprising: an input port, a data conversion unit and a power supply unit, wherein:
the input port receives the music information output from an earphone jack of the digital music broadcasting device;
the data conversion unit modulates digital music transferred from the digital music broadcasting device to radio signals and emit the radio signals which are received by the audio system or a radio for broadcasting; and
the power supply unit provides electric power required by the digital music player.

2. The digital music player of claim 1, wherein the data conversion unit is a frequency modulation circuit.

3. The digital music player of claim 1, wherein the data conversion unit is an amplitude modulation circuit.

4. The digital music player of claim 1 further including an amplifier.

5. The digital music player of claim 1, wherein the electric power source of the power supply unit is a battery.

6. The digital music player of claim 1, wherein the power supply unit further includes:
a power supply plug for connecting to an external power supply to provide electric power for the digital music player; and
a power supply transformer for transforming the electric power input from the power supply plug to an operation voltage of the digital music player.

7. The digital music player of claim 1, wherein the data conversion unit is a cassette tape and an extension line which connects to the cassette tape and the digital music player; wherein the cassette tape is allowed to be disposed in a cassette tape slot of the audio system or the radio to transfer digital music signals from the cassette tape to the magnetic head of the audio system or the radio for broadcasting the digital music.

8. The digital music player of claim 1 further including a storage device connector.

9. The digital music player of claim 8, wherein the storage device connector is an insert slot of a digital memory card, the memory card being selected from the group consisting of CF, MD, SD, MMC, SM and MS.

10. The digital music player of claim 8, wherein the storage device connector is an insert slot of a USB interface.
